(19) United States
(12) Patent Application Publication
(10) Pub. No.: US 2004/0244595 A1
(43) Pub. Date: Dec. 9, 2004

(54) C-pap medical breathing apparatus supply hose, universal, disposable, and charcoal/medical Hepa filter.

(76) Inventor: Gordon Laing Elliot, Wauconda, WA (US)

Correspondence Address: Gordon Laing Elliot, 15-145 Antioch Road, White City, OR, 97503, US

(21) Appl. No.: 10/452,014

(22) Filed: Jun. 3, 2003

(51) Int. Cl. B01D 53/02

(52) U.S. Cl. 96/134; 55/486

(57) ABSTRACT

The Laing Medical C-Pap Breathing Apparatus Disposable Inline Hepa Filter is a new concept in filter applications to C-Pap breathing machines. Most manufacturers have a primary filter application to their suction or induction of their units and only their filters can be used. My filter fits on the one inch universal discharge fitting found on all units in which the air supply hose connects with the application of a little rubber adaptor boot. The Laing Medical C-Pap Breathing Apparatus Disposable Inline Hepa Filter is a superior two stage filter that is disposable and fits any C-Pap breathing unit.

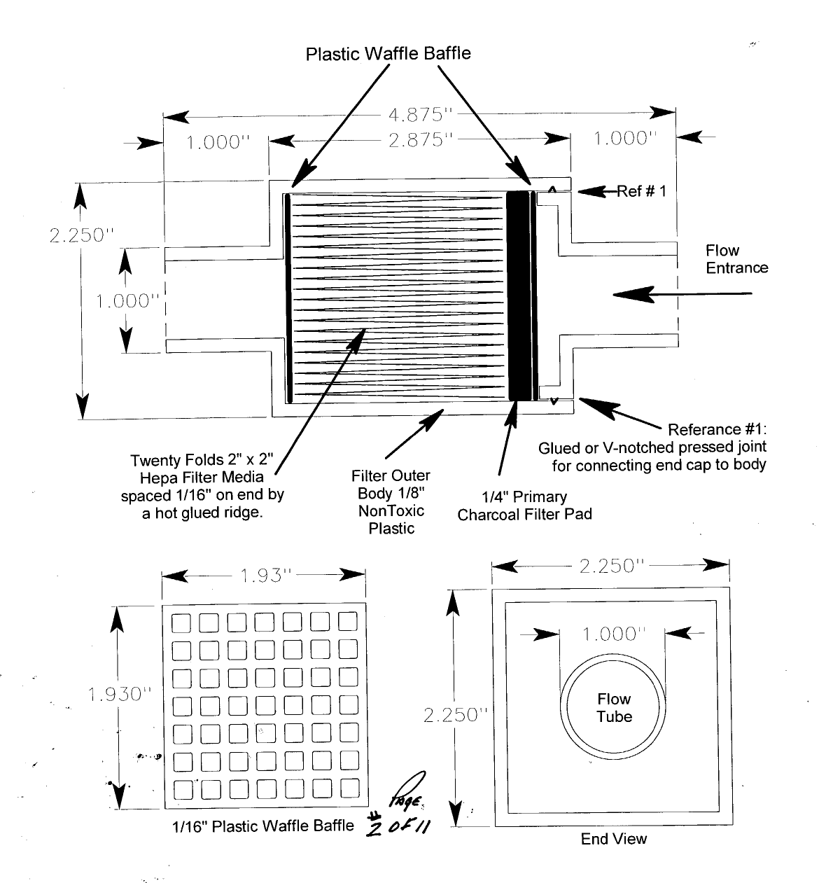

This is a written description of the Laing C-pap inline Hepa Filter, the process of fabrication, assembly and application of invention.

The filter dimensions consist of an overall length of 4.875 inches from orifice to orifice. A cube 2.250 inch square with a cube length of 2.875 inches. Centered at each end of the cube is 1.000 inch long by 1.000 inch in diameter flow tubes. The filter wall body consists of ⅛^{th} inch mold injected non toxic plastic or hypersensitive plastic. The plastic body consist of two parts which is the media housing and a glued or V-notched pressed joint for connecting the end cap to body. There are two 1.93 inch plastic waffle baffles inside each end of media chamber that contain the media to the filter. Internal tabs located on the cap press up against the intake baffle to produce needed internal head space to allow even flow through the filter.

Filter media consists of a 0.025 inch primary charcoal filter pad. The secondary filter consists of twenty folds 2.000 inches in width by 2.000 inches in length of medical grade hepa filter media. Two hot glue ridges running the length of the media produce the spacing between folds necessary for uniform air flow.

The Laing filter is a universal filter that will attach to the standard 1.000 inch flow tubes found on all Medical C-Pap Breathing apparatus with a simple application of a 1.000 inch rubber boot that allows Filter to Machine.

1. I claim, as my invention, a universal applied disposable two stage filter, consisting
Of a primary charcoal filter pad with a secondary medical heap filter media. This filter is applied with a rubber adaptor boot to any C-Pap medical breathing unit. The air supply hose to the patient is then attached to the discharge end of the filter.
I further claim the intent of this unit is air filtration to eliminate foreign air borne particulate objects such as, but not limited to mole spores, smoke by-products, dust and pollens.
Nasal congestion due to allergies and air quality are greatly improved, if not eliminated, by the application of my filter to any C-Pap medical breathing supply unit.
